(19) United States
(12) Patent Application Publication
(10) Pub. No.: US 2011/0248670 A1
(43) Pub. Date: Oct. 13, 2011

(54) CHARGING POWER SOURCE APPARATUS

(76) Inventors: Kazuo Yamazaki, Kanagawa (JP); Kouji Murakami, Fukuoka (JP); Yukihiro Terada, Kanagawa (JP); Tamiji Nagai, Tokyo (JP); Toshio Nagai, Tokyo (JP)

(21) Appl. No.: 12/309,793

(22) PCT Filed: Jul. 24, 2007
(86) PCT No.: PCT/JP2007/064491

§ 371 Date: Jan. 30, 2009

(30) Foreign Application Priority Data
Jul. 31, 2006 (JP) 2006208617

(51) Int. Cl. H02J 7/04

(52) U.S. Cl. 320/107

(57) ABSTRACT

There is provided a charging power source apparatus by which quick charging can be carried out within a required range without imposing a burden on a secondary battery or a charging circuit. The charging power source apparatus is equipped with a plurality of control modes (e.g. normal charging mode and quick charging mode) for operating respectively with a plurality of output characteristics where the magnitudes of output currents being limited are different, and a detecting circuit for detecting a voltage appearing between the output terminals, and is configured such that one of the plurality of control modes is selected based on detection result from the detection circuit to perform an output operation.

### TECHNICAL FIELD

The present invention relates to a charging power source apparatus to supply electric power to a charger of a secondary battery.

### BACKGROUND ART

Constant current charging in a predetermined period is generally carried out to a secondary battery, such as a lithium ion battery and a nickel hydrogen battery. Also the technique of carrying out quick charging by increasing the current value of the constant current charging to be five times or ten times as large as a defined amount has been put to practical use.

Moreover, presently small-sized electronic equipment, such as a mobile telephone, which equipment uses a secondary battery, incorporates the control circuits of a constant current and a constant voltage in a charging power source apparatus (such as an AC adapter), and provides a switch to turn on and off the input of a current and a constant voltage charging regulator circuit in a charging circuit on the side of the electronic equipment incorporating the secondary battery therein on the other hand. The electric equipment thus carries out the charging of the secondary battery generally. In such a system, in a constant current charging period, the current switch of a charging circuit is turned on, and the constant current charging is carried out by the current control of the power source apparatus. In a constant voltage charging period, the constant voltage output of the power source apparatus is stepped down to a predetermined voltage by the regulator circuit of the charging circuit to carry out the constant voltage charging.

Moreover, the following disclosures were made pertaining to the techniques related to the invention of the present application. That is, Patent Publication 1 disclosed the technique of providing two charging electric power sources to be used by being switched between in an initial charging period and the other periods. Moreover, Patent Publication 2 disclosed the technique of mutually switching two kinds of charging operations to carry out the quick charging of a secondary battery.
[Patent Publication 1] Japanese Patent Application Laid-Open Publication No. Hei 10-28338
[Patent Publication 2] Japanese Patent Application Laid-Open Publication No. Hei 11-191934

### DISCLOSURE OF THE INVENTION

### The Problems to be Solved by the Invention

A system to carry out charging in a constant current mode by the current control by a power source apparatus enables the quick charging of a secondary battery by enlarging a constant current output of the power source apparatus to two times, five times, ten times, and so forth, as large as a normal quantity.

However, the quick charging is good for a battery voltage suitable for the quick charging, but when the battery voltage is in a high range or the battery voltage is extremely low, the burden of the secondary battery increases if the charging current is enlarged, and which situation is not preferable.

Moreover, if the charging current remains large in a period in which the battery voltage becomes high and the power source apparatus shifts its mode from the constant current mode thereof to the constant voltage mode, then a large current flows through a transistor that operates as a resistor in a regulator circuit, and consequently the problem in which the heating value of the transistor becomes excessive arises.

It is an object of the present invention to provide a charging power source apparatus capable of carrying out quick charging within a required range without imposing any burdens on a secondary battery and a charging circuit.

### Means for Solving the Problems

In order to attain the object mentioned above, the present invention is a charging power source apparatus having output characteristics by which magnitudes of output currents are limited when a load resistor is small, the apparatus comprising: a plurality of control modes by which the charging power source apparatus operates respectively to have the plurality of output characteristics by which the limited magnitudes of the output currents are mutually different; and a detection circuit for detecting a voltage appearing between output terminals, wherein the charging power source apparatus selects one of the plurality of control modes on a basis of a detection result of the detection circuit to perform an output operation.

By such means, it is possible to supply a charging current by switching it to have a suitable magnitude according to a battery voltage. Thereby, quick charging can be carried out in a range of not imposing any burdens on a secondary battery and a charging circuit.

To put it concretely, the charging power source apparatus may be configured so as to include: a first control mode to maintain an output voltage at a voltage higher than a full charge voltage of the secondary battery when the load resistor is large, and to limit an output current to a first limited current when the load resistor is small; and a second control mode to maintain the output voltage at a voltage equal to or less than the full charge voltage of the secondary battery when the load resistor is large, and to limit the output current to a second limited current larger than the first limited current when the load resistor is small.

To put it more concretely, the magnitude of the first limited current may be within a range from 0.5 C to 1.5 C, more preferably within a range from 0.8 C to 1.2 C, of the secondary battery of a charging object, and the magnitude of the second limited current may be larger than 2 C (for example, within a range from 2 C to 20 C), more preferably be larger than 5 C (for example, within a range from 5 C to 20 C) of the secondary battery of the charging object.

Then, the charging power source apparatus may be configured to switch the second control mode to the first control mode when the voltage appearing between the output terminals exceeds a threshold voltage set to a predetermined voltage lower than the full charge voltage of the secondary battery.

By such a configuration, the charging power source apparatus can be configured to execute quick charging only in a range in which the burdens on the secondary battery and the charging circuit are small and the charging rate of the secondary battery is low to be desired to carry out the quick charging.

Further preferably, the charging power source apparatus may be configured so that the output operation thereof may start in the first control mode or in a control mode in which a limited current is smaller than the first limited current of the first control mode when a current output is started from a state in which the current output is zero.

By such means, no large currents for quick charging are abruptly flow when the current output is started from the state in which the current output is zero, and consequently it can be avoided to impose a large burden on an output destination by mistake. Moreover, there is also a case where a current output is started on the basis of improper connection such as the connection of a circuit other than the charging object to the power source apparatus by mistake and the short-circuit of the output terminals of the power source apparatus, and accordingly it is possible to lessen the disadvantage at the time of the improper connection by starting the current output from the control mode in which the output current is small.

Moreover, preferably the charging power source apparatus may further comprises an output stopping circuit to temporarily stop the current output, and the charging power source apparatus may be configured to be able to perform switching control of the plurality of control modes on the basis of the detection result of the detection circuit in a state in which the current output is stopped by the output stopping circuit.

By such a configuration, the accurate switching of the control modes based on the battery voltage of the secondary battery can be carried out. The value of a charged voltage of the secondary battery appears to be higher dependently on the resistance component on a current pathway to the secondary battery, and consequently the value does not accurately express the state (such as the charging rate) of the secondary battery. The accurate switching control according to the state of the secondary battery can be carried out by carrying out the switching of the control modes on the basis of the battery voltage at the time of stopping charging accordingly. However, the means can be used only when the charging circuit of the type of outputting the voltage of the secondary battery to input terminals on the charging circuit side at the time of stopping charging is used.

Further preferably, the charging power source apparatus may be configured to include a third control mode to limit the output current to a third limited current equal to or less than 0.3 C of the secondary battery of the charging object, and to start the output operation in the third control mode when the current output is started from the state in which the current output is zero.

By such means, the charging power source apparatus is not switched to a pertinent control mode until a small current output is first performed at the time of output starting, and consequently, it is possible to avoid outputting, for example, a large current in a voltage range unsuitable for quick charging. Moreover, it becomes also possible to carry out pre-charging of the secondary battery by means of the third control mode.

Moreover, preferably the charging power source apparatus may be configured to include a switch circuit for connecting/releasing a high impedance circuit to/from the output terminals, and to start the output operation in a state in which the high impedance circuit is connected when the current output is started from the state in which the current output is zero.

By such a configuration, disadvantages can be minimized at the time of the improper connection, such as the short-circuit of the output terminals and the connection to another circuit that cannot deal with the charging power source apparatus.

Furthermore preferably, the charging power source apparatus may include a second detection circuit for detecting the output voltage or the output current, and a stopping circuit to stop the output operation when the second detection circuit detects an abnormal output voltage or an abnormal output current.

Thereby, the output operation is stopped when an unprescribed operation arises, and consequently the disadvantage that a state including a problem lasts for a long time can be avoided.

Moreover, in order to settle the problem mentioned above, the present invention is a charging power source apparatus to perform current control to limit a magnitude of an output current when a load resistor is small, and the charging power source apparatus is configured to have a voltage-current characteristic by which the limited magnitude of a value of the current stepwise changes according to an output voltage.

To put it concretely, the charging power source apparatus is configured to have the voltage-current characteristic in which the output current is limited to a first limited current in a range in which the output voltage is higher than a first voltage equal to or less than a full charge voltage of a secondary battery and the output current is limited to a second limited current larger than the first limited current in a range in which the output voltage is lower than the first voltage.

Even in such a configuration, the charging current of the secondary battery can be supplied after being switched to a suitable current value according to the battery voltage, and quick charging can be carried out without imposing any burdens on the secondary battery and the charging circuit.

### Effects of the Invention

According to the present invention, the charging current of the secondary battery can be supplied after being switched to a suitable current value according to the battery voltage and the like, and consequently the effect capable of making a large charging current for quick charging flow within a range of imposing no burdens on the secondary battery and the charging circuit can be obtained.

Moreover, since the charging power source apparatus of the present invention is configured not to abruptly perform the outputting of a large current at the time of output starting when a charging circuit is connected to the charging power source apparatus, the charging power source apparatus has, for example, the following effects: it is possible to avoid the outputting of a large current in a voltage range unsuitable for quick charging, and it is possible to minimize disadvantages even if an improper connection, such as the short-circuit of the output terminals or the connection of another circuit incapable of dealing with the charging power source apparatus, arises.

### BRIEF DESCRIPTION OF THE DRAWINGS

FIG. 1 is a block diagram showing the schematic configuration of a system connecting a charging power source apparatus of a first embodiment of the present invention to a charging circuit;

FIG. 2 is a block diagram showing the internal configurations of the charging power source apparatus and charging circuit of FIG. 1;

FIG. 3 is a graph showing output characteristics of the charging power source apparatus of FIG. 1;

FIG. 4 is a graph showing a charging characteristic of a secondary battery by the charging power source apparatus of FIG. 1;

FIG. 5 is a flow chart for illustrating the flow of an operation of the charging power source apparatus of FIG. 1;

FIG. 6 is a graph showing another example of the output characteristics applicable to the charging power source apparatus;

FIG. 7 is a graph showing the other examples of the output characteristics applicable to the charging power source apparatus;

FIG. 8 is a block diagram showing the schematic configuration of a charging power source apparatus of a second embodiment;

FIG. 9 is a graph showing a charging characteristic of the secondary battery by the charging power source apparatus of the second embodiment;

FIG. 10 is a block diagram showing the schematic configuration of a charging power source apparatus of a third embodiment;

FIG. 11 is a graph showing the output characteristics of the charging power source apparatus of the third embodiment;

FIG. 12 is a graph showing outputs for illustrating an operation of the charging power source apparatus of the third embodiment to shift the charging mode thereof from the pre-charging mode to quick charging mode thereof;

FIG. 13 is a block diagram showing the configurations of a charging power source apparatus of a fourth embodiment and a charging circuit to which the charging power source apparatus is connected;

FIG. 14 is a flow chart for illustrating the flow of a charging operation by the charging power source apparatus of the fourth embodiment;

FIG. 15 is a block diagram showing the configurations of a charging power source apparatus of a fifth embodiment and a charging circuit to which the charging power source apparatus is connected;

FIG. 16 a flow chart for illustrating the flow of a charging operation by the charging power source apparatus of the fifth embodiment;

FIG. 17 is a block diagram showing the schematic configuration of a charging power source apparatus of a sixth embodiment; and

FIG. 18 is a graph showing output characteristics during a charging operation of the charging power source apparatus of the sixth embodiment.

### EXPLANATION OF REFERENCE NUMERAL

10, 10A-10E: charging power source apparatus
11: SW converter circuit
12: voltage detection circuit
13: switching control circuit
14: charging stopping circuit
15: timer
16: timer
17: signal detection circuit

R10: high impedance element
18: switch circuit
20: charging circuit
31: voltage and current detection circuit
32: stop control circuit
33: LED blinking circuit
E2: secondary battery

### THE BEST MODE FOR CARRYING OUT THE INVENTION

In the following, embodiments of the present invention will be described with reference to the attached drawings.

### First Embodiment

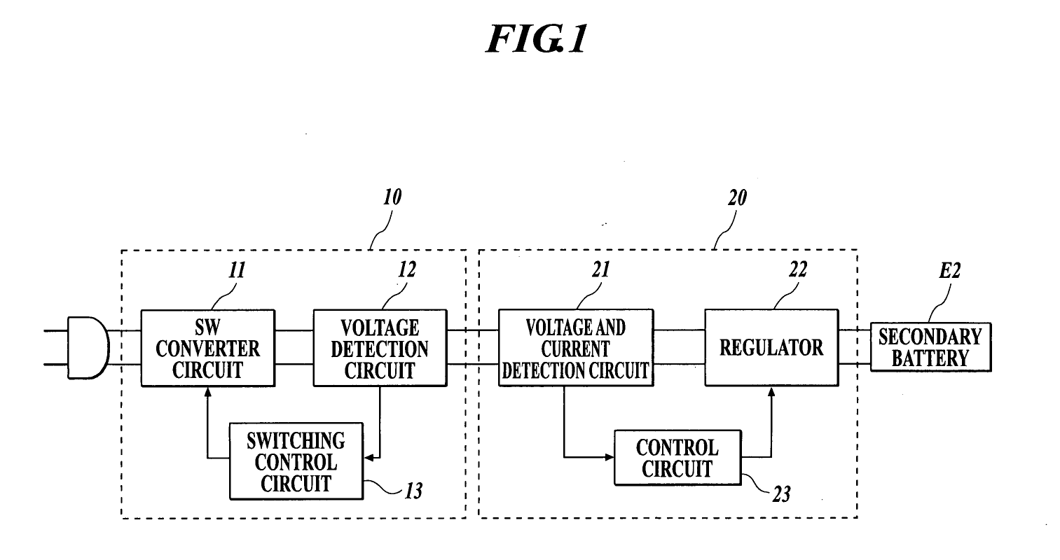

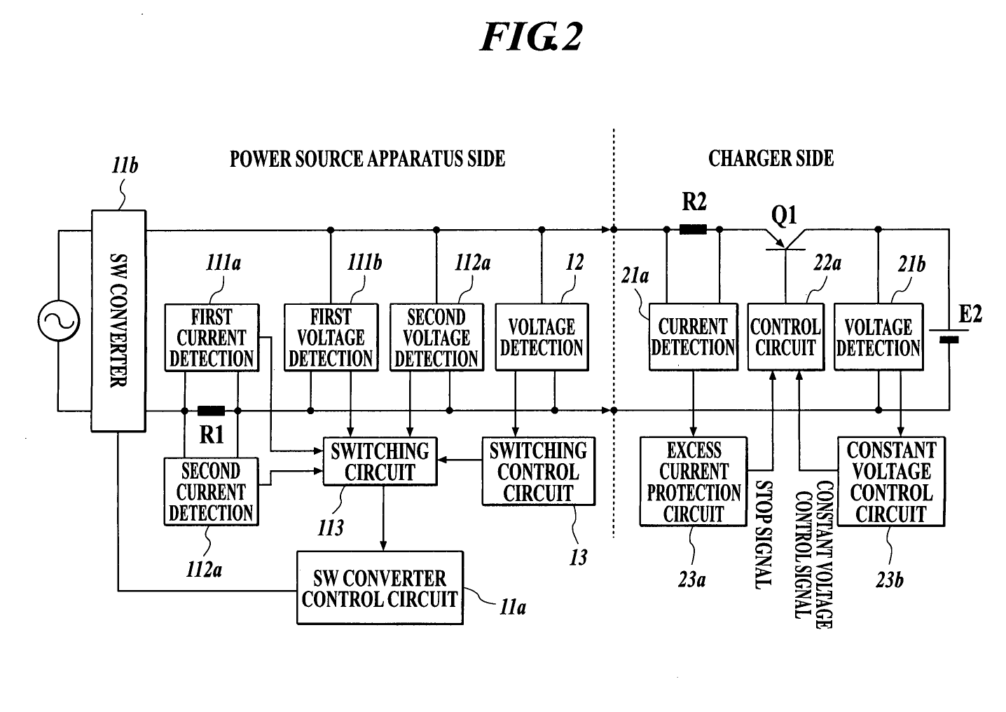

FIG. 1 is a block diagram showing the schematic configuration of a charging power source apparatus 10 of a first embodiment of the present invention and a charging circuit 20, to which the charging power source apparatus 10 is connected, and FIG. 2 is a block diagram showing the internal configurations of theirs.

The charging power source apparatus 10 of the present embodiment is a power source apparatus dedicated for charging for carrying out electric power supply by being connected to the charging circuit 20 of a secondary battery E2, such as a lithium ion battery.

The lithium ion battery generally performs constant current charging with a current of, for example, about 1 C until the voltage of the lithium ion battery reaches the full charge voltage (for example, 4.2 V) thereof, and after the voltage has reached the full charge voltage, constant voltage charging is performed at the voltage. After that, when the charging current has become very small, the charging is completed. The “1 C” indicates a current value to discharge the whole capacity of the secondary battery E2 for one hour here. Moreover, the operation mode at the time of the constant current charging is called as a constant current mode, and the operation mode at the time of the constant voltage charging is called as a constant voltage mode.

As shown in FIGS. 1 and 2, the charging circuit 20 is provided with a switch for inputting a current from the power source apparatus 10 as it is, the excess current protection function of intercepting inputting, and the regulator function of stepping down a power source voltage to carry out constant voltage outputting at the time of the constant voltage mode.

That is, as shown in FIG. 2, a voltage detection circuit 21b detects a charged voltage, and a constant voltage control circuit 23b compares the detected charged voltage with a reference voltage. Then, a transistor Q1 is kept in its on-state until the charged voltage becomes the full charge voltage of the secondary battery E2. Thereby, the output current of the power source apparatus 10 flows into the secondary battery E2 as it is, and the charging of the constant current mode is thus realized. Moreover, when the charged voltage becomes the full charge voltage, an input voltage is stepped down by performing the linear control of the transistor Q1 for a series regulator, and the charging of the constant voltage mode is carried out with the charged voltage being kept at a constant voltage. Moreover, the detected voltage by a current detection circuit 21a is monitored by an excess current protection circuit 23a as the excess current protection function, and a stop signal is output to a control circuit 22a of a regulator 22 when the detected voltage becomes a certain value or more. Then the transistor Q1 is turned off.

The charging power source apparatus 10 is composed of, as shown in FIG. 1, a switching converter circuit 11 to perform current control and voltage control to carry out an output operation of a predetermined output characteristic, a voltage detection circuit 12 to detect a voltage generated at output terminals, a switching control circuit 13 to switch the output mode of the switching converter circuit 11 on the basis of the detection result, and the like. Two kinds of output characteristics are set to the switching converter circuit 11, and the output operation is performed in the output characteristic switched by the switching control circuit 13.

As shown in FIG. 2, to put it concretely, the switching converter circuit 11 is provided with two systems of detection circuits 111a, 111b, 112a, and 112b of currents and voltages for the control of an output current and an output voltage, and the detection signals of them are switched by a switching circuit 113 to be supplied to a SW converter control circuit 11a. Thereby, two kinds of output characteristics can be realized.

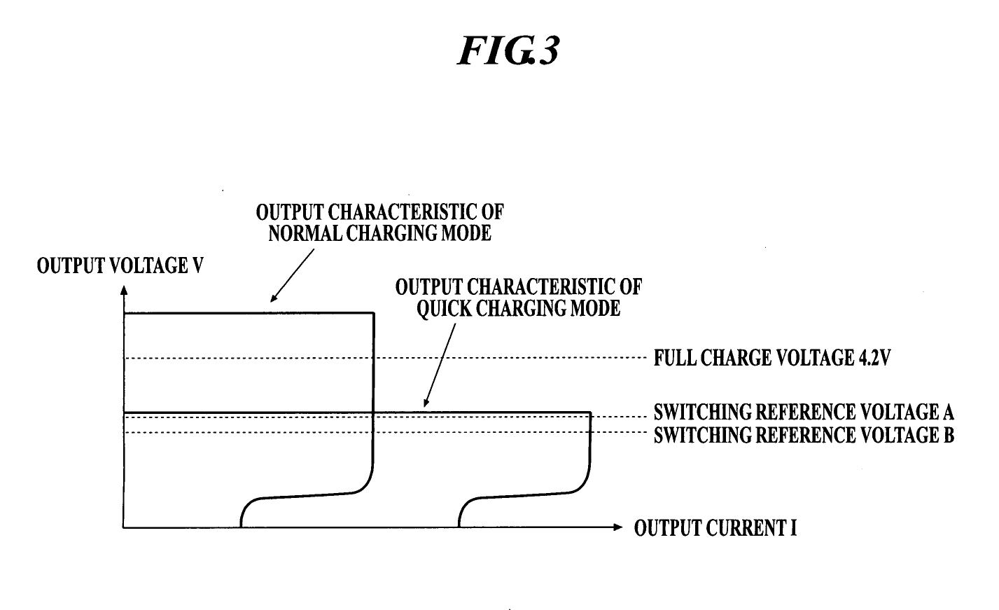

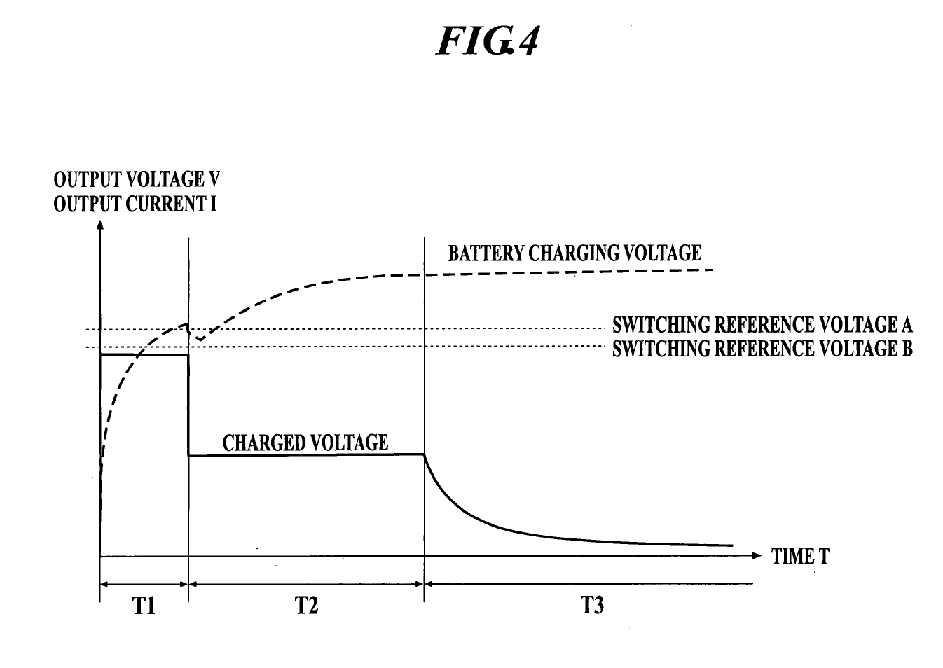

FIG. 3 shows an output characteristic diagram of the charging power source apparatus 10, and FIG. 4 shows a charging characteristic diagram of the secondary battery E2 by the charging power source apparatus 10.

The switching converter circuit 11 has two kinds of output characteristics shown in FIG. 3. One of them is an output characteristic of a normal charging mode, and the other of them is an output characteristic of a quick charging mode.

The output characteristic of the normal charging mode has an output characteristic in which an output current is limited to a current value of about 1 C (for example, within a range from 0.8 C to 1.2 C) when the load resistor connected to the output terminals is small (that is, when the charging rate of the secondary battery 2E is low and the charged voltage thereof is low), and in which predetermined constant voltage output is performed when the charging rate of the secondary battery 2E becomes high and the output voltage becomes high. The voltage of the constant voltage output is set to a voltage exceeding the full charge voltage 4.2 V in order to be able to perform the constant voltage charging at the full charge voltage.

The output characteristic of the quick charging mode has an output characteristic in which an output current is limited to a current value of about 2 C (or within a range from 2 C to 20 C) when the load resistor is small, and in which constant current voltage output is performed at a voltage lower than the full charge voltage 4.2 V when the output voltage becomes higher.

Then, the switching control circuit 13 is configured so as to switch the output characteristic from that of the quick charging mode to that of the normal charging mode when the output voltage becomes a switching reference voltage A or more, and to switch the output characteristic from that of the normal charging mode to that of the quick charging mode when the output voltage becomes a switching reference voltage B or less. The switching reference voltage A is set to a value somewhat lower than the output voltage value in the constant voltage mode of the output characteristic in the quick charging mode here.

Moreover, the SW converter circuit 11 is configured to stand by in the control operation of its normal power source mode when the output current is zero as its startup characteristic.

Next, the charging operation using the charging power source apparatus 10 of the above-mentioned configuration will be described.

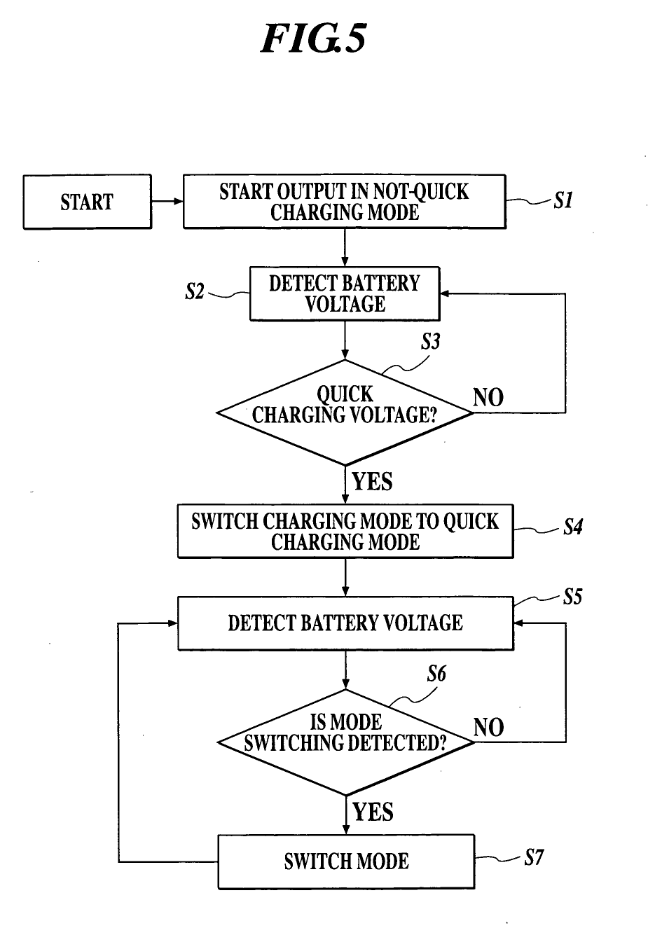

FIG. 5 shows a flow chart for illustrating the flow of the operation of the charging power source apparatus 10.

When the charging circuit 20 is connected to the power source apparatus 10 and output is started, the output is first started in the output characteristic of the normal charging mode (Step S1). Since the charging power source apparatus 10 operates in the normal charging mode at the time of output starting regardless of the charging rate of the secondary battery E2, the disadvantage can be avoided that a large current abruptly flows to impose an excessive burden on the secondary battery E2 and the charging circuit 20.

Successively, when the voltage detection circuit 12 detects an output voltage to be the switching reference voltage B or less, the charging power source apparatus 10 is switched to its quick charging mode (Steps S3 and S4). Consequently, charging is performed with a quick charging current when the charging rate of the secondary battery E2 is low as shown in a period T1 of FIG. 4.

In the operation of the quick charging mode, further detection of the output voltage is performed (Step S5), and the detected output voltage is compared with the switching reference voltage A or the switching reference voltage B (Step S6). Then, when the output voltage exceeds the switching reference voltage A, the charging power source apparatus 10 is switched to its normal charging mode (Step S7). Consequently, charging is performed with a normal charging current in the range in which the charging rate of the secondary battery E2 is high as in a period T2 of FIG. 4.

After that, when the charged voltage reaches the full charge voltage, the charging circuit 20 performs the constant voltage control, and the charging current lowers. In association with that, the output voltage of the charging power source apparatus 10 rises, and the charging power source apparatus 10 shifts its mode to that of a constant voltage equal to or more than the full charge voltage (period T3 in FIG. 4). Then, when the charging current becomes small, the charging is ended.

As described above, according to the charging power source apparatus 10 of the present embodiment, it is possible to suitably switch the charging current of the secondary battery E2 to supply the switched charging current to the secondary battery E2 according to the battery voltage. Thereby, it becomes possible to perform the control to perform the quick charging only in the range in which the charging rate of the secondary battery E2 is low and the quick charging is desired, and to carry out the normal charging in the range in which the charging rate is high and if the quick charging is carried out, an excessive burden is imposed on the secondary battery E2 and the charging circuit 20.

Moreover, since the voltage value of the constant voltage output in the quick charging mode is set to be lower than the full charge voltage of the secondary battery E2, the effect of enabling the prevention of the overcharge of the secondary battery E2 can be obtained even if the operations of the quick charging modes continue without performing the switching of the output mode owing to some abnormality.

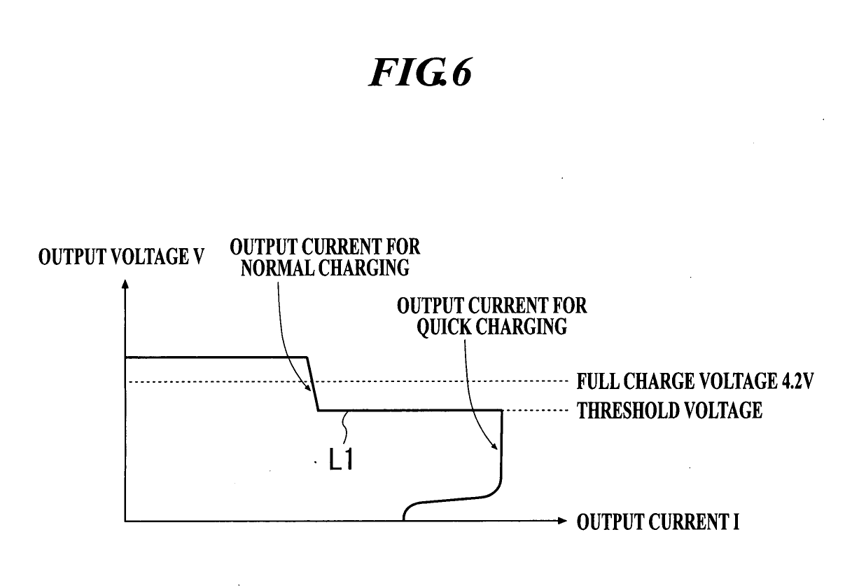

FIG. 6 shows another example of the output characteristic applicable to the charging power source apparatus 10.

Although the example of providing the two output characteristics to the charging power source apparatus 10 in advance to use the two output characteristics by switching them is shown in the above-mentioned embodiment, the charging power source apparatus 10 may have the voltage-current characteristic in which the magnitude of the output current stepwise changes according to an output voltage as shown in the output characteristic diagram of FIG. 6. In this case, the quick charging current value (within a range of, for example, 2 C to 10 C) and the normal charging current value (within a range of 0.8 C to 1.2 C) may be set to be mutually switched at about a threshold voltage lower than the full charge voltage of the secondary battery E2.

Even if such an output characteristic is used, the charging current changes in two stages according to the battery voltage, and the effect can be obtained that the charging operation can be carried out without imposing any burdens on the secondary battery E2 and the charging circuit 20.

Incidentally, in the output characteristic, a slight gradient of the output voltage to rise as the output current becomes smaller may be given to the part of a characteristic line L1 on which the output for quick charging transits to the output for normal charging.

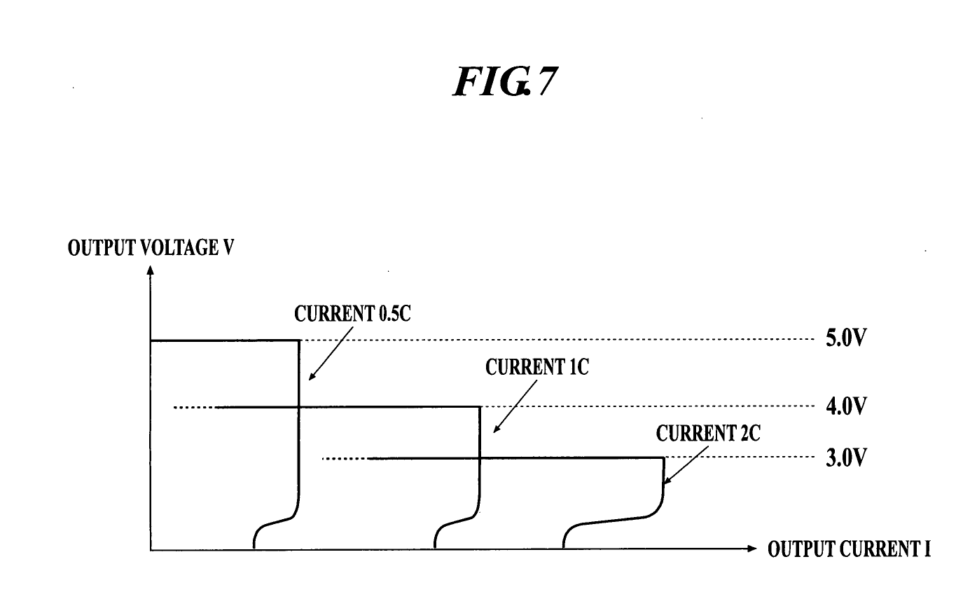

FIG. 7 shows the other examples of the output characteristics applicable to the charging power source apparatus 10.

Moreover, as shown in FIG. 7, three or more output characteristics of the charging power source apparatus 10 may be provided in advance, and these output characteristics may be used by being suitably switched according to the battery voltage. In this case, the limited values of the current values and voltage values of each of the output characteristics may be set so that an output characteristic having a higher upper limit of the output current may have a lower upper limit of the output voltage.

Even if such output characteristics are used, a pertinent charging operation according to a battery voltage can be realized by switching the charging currents in multi-stages according to the battery voltage.

### Second Embodiment

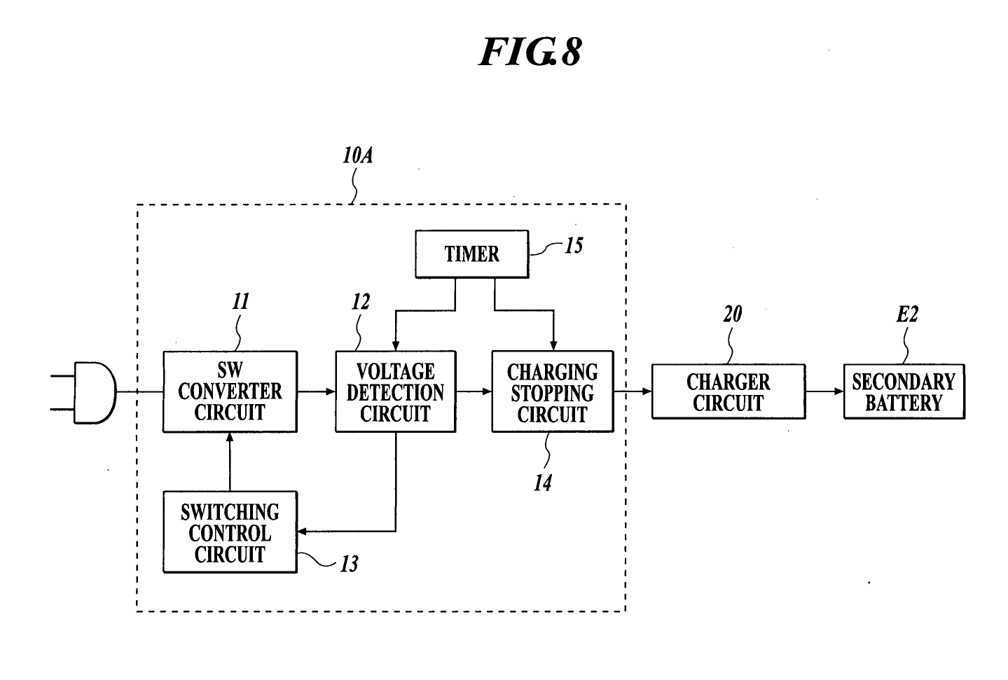

FIG. 8 shows a block diagram showing the schematic configuration of a charging power source apparatus 10A of a second embodiment.

The charging power source apparatus 10A of the second embodiment is configured to use the battery voltage of the secondary battery E2 in the state in which the charging thereof is stopped as the voltage detected for switching the output mode in place of the output voltage of the charging power source apparatus 10A like the first embodiment.

Accordingly, the charging power source apparatus 10A is provided with a charging stopping circuit 14 to intercept an output of the SW converter circuit 11 to make the output terminals be in their floating states, and a timer 15 to synchronize the stopping operation of the charging stopping circuit 14 with the detection operation of the voltage detection circuit 12 to execute the operations every predetermined period in addition to the configuration of the first embodiment.

Moreover, in the present embodiment, the charger circuit 20 is limited to that of the type outputting the voltage of the secondary battery E2 to the input terminals when the input voltage is stopped.

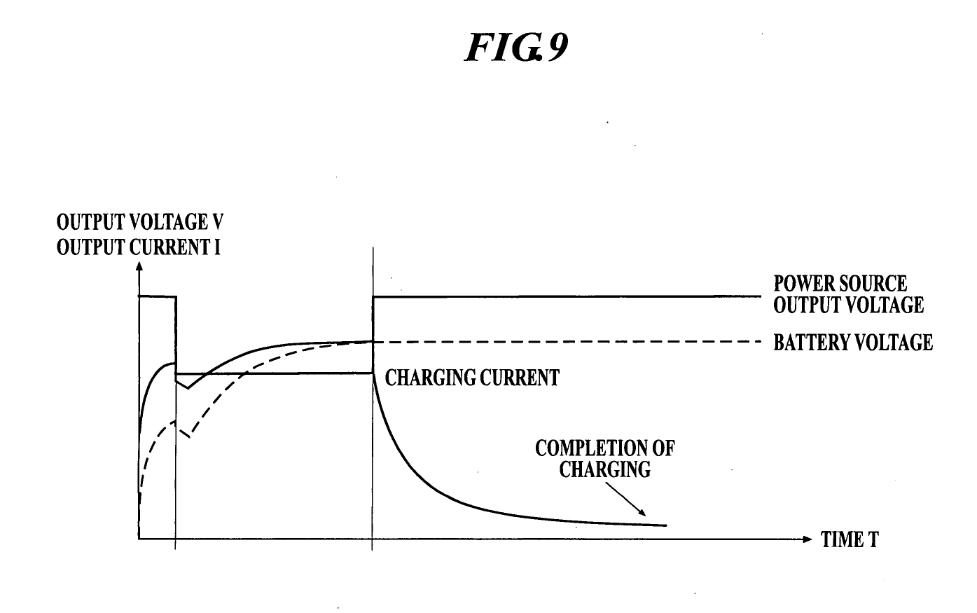

FIG. 9 shows a graph of the charging characteristics of secondary battery E2 by the charging power source apparatus 10A.

As shown in the characteristic graph, a shift is produced between the battery voltage (shown by a dotted line in FIG. 9) of the secondary battery E2, which stops charging, and the output voltage (shown by a solid line in FIG. 9) of the charging power source apparatus 10A. The direct detecting of the battery voltage of the secondary battery E2 to perform the switching of the output characteristics according to the detected voltage enables the switching of the charging operations to be carried out in harmony with the actual state of the secondary battery E2.

### Third Embodiment

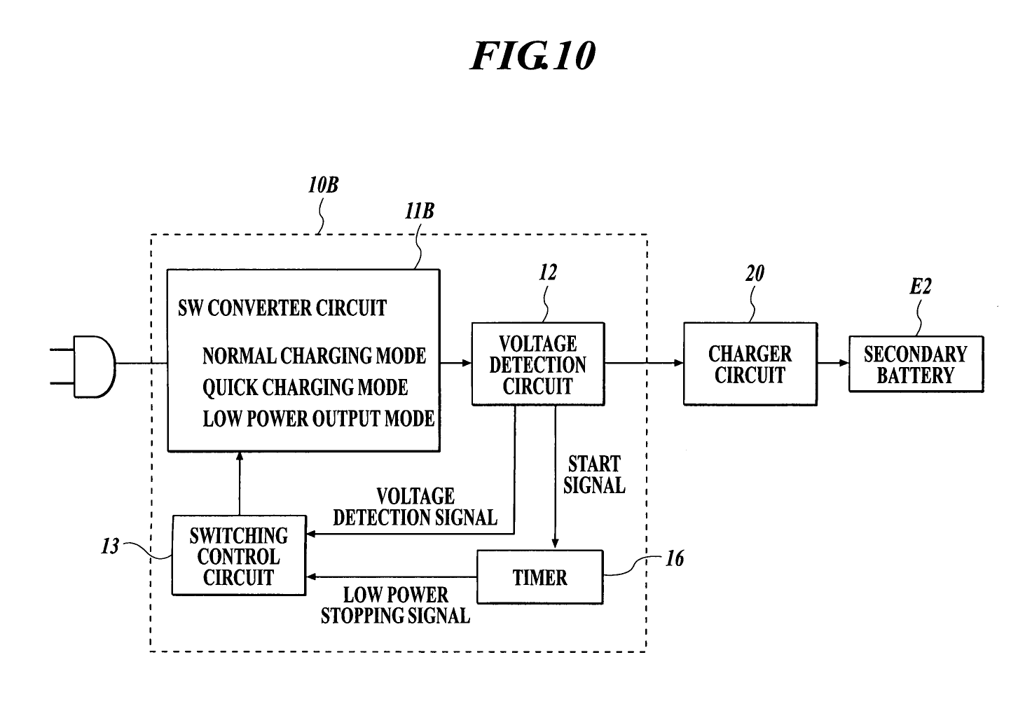

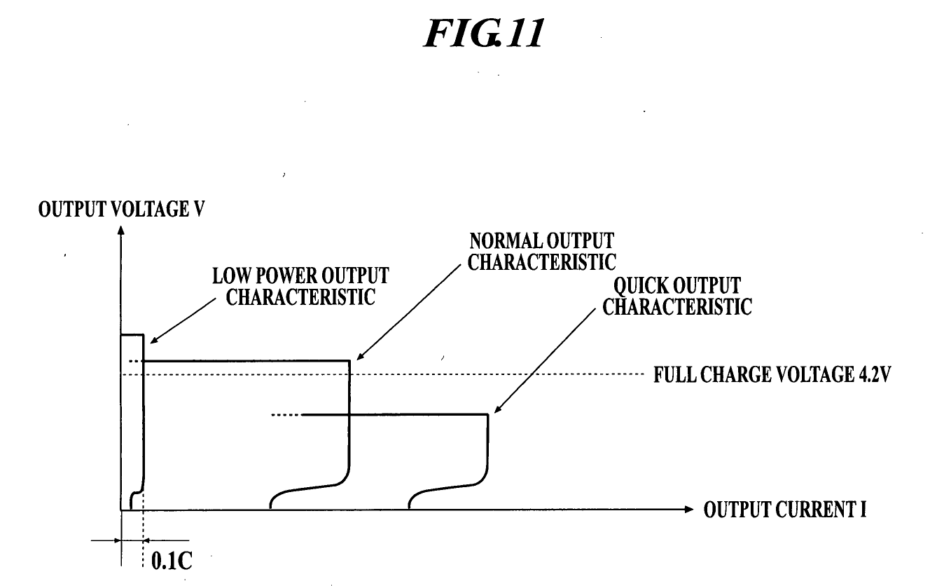

FIG. 10 is a block diagram showing the schematic configuration of a charging power source apparatus 10B of a third embodiment, and FIG. 11 is a graph showing the output characteristics of the charging power source apparatus 10B.

The charging power source apparatus 10B of the third embodiment adds a low power output characteristic, by which an output current is made to be very small, to a SW converter circuit 11B, and performs the output of the low power output characteristic first at the startup time of starting charging to check whether a battery voltage can perform quick charging or not, in addition to the configuration of the first embodiment. Moreover, the charging power source apparatus 10B is configured to carry out pre-charging by means of the low power output characteristic when the battery voltage of the secondary battery E2 is very low.

The low power output characteristic is the characteristic by which a current value to be almost a constant current output is set to a pre-charging current value 0.1 C (or within a range of 0.02 C to 0.2 C) and the voltage value at which the voltage values are constant voltage outputs is set to a voltage equal to the full charge voltage or more, as shown in FIG. 11.

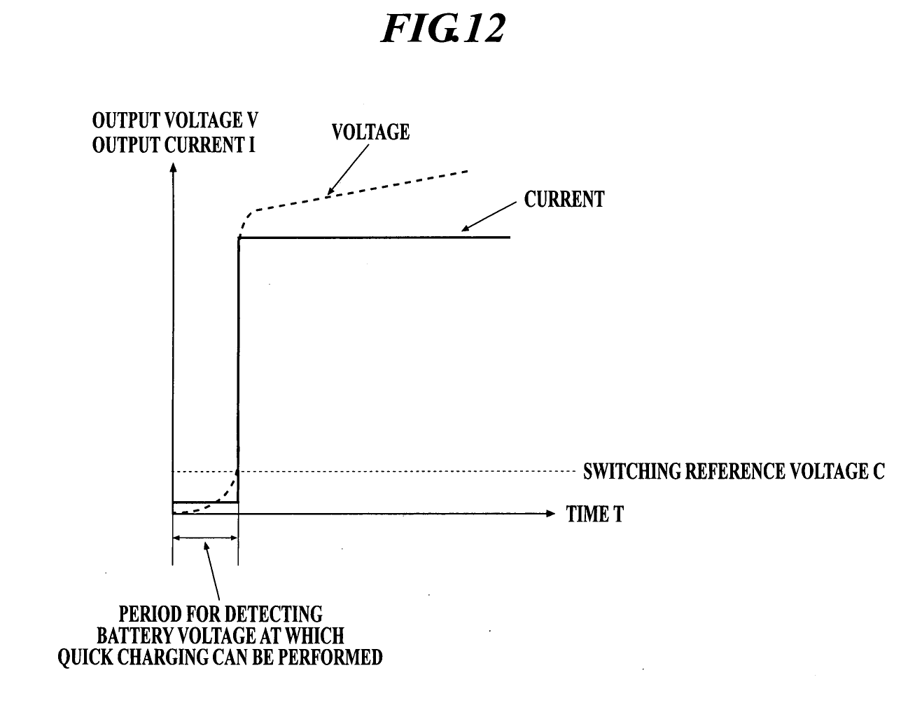

The switching control circuit 13 is configured to carry out a control operation to compare a detected voltage with a switching reference voltage C to switch the low power output mode and the quick charging mode mutually in addition to the control operation to compare the detected voltage with the switching reference voltages A and B to switch the quick charging mode and the normal charging mode mutually, as shown in FIG. 12.

Moreover, at charging starting time when the charger circuit 20 is connected to the power source apparatus 10B, the start mode of the SW converter circuit 11B is fixed to the low power output mode, and then the detection of the battery voltage is to be performed in a definite period of time to perform the selection of the output mode according to the battery voltage.

In order to carry out such a control operation, the power source apparatus 10B is configured to provide, for example, the function of detecting the charging starting time to output a start signal to the voltage detecting circuit 12, and to input the output start signal to a timer 16 so that the timer 16 may output a signal to the switching control circuit 13 for releasing the fixed state of the low power output mode after the definite period of time from the charging starting time.

FIG. 12 shows an output graph for illustrating an operation of the charging power source apparatus 10B at the time of shifting its charging mode from the pre-charging mode to the quick charging mode.

According to such a charging power source apparatus 10B, if the battery voltage of the secondary battery E2 is very low, then pre-charging is first performed in the low power output mode, and when the battery voltage returns to a voltage at which quick charging can be carried out, the charging mode of the charging power source apparatus 10B is shifted to the quick charging.

Moreover, when charging is started from a state in which the charging rate of the secondary battery E2 is already high, a current flows to the secondary battery E2 in the low power output mode only in the definite period of time, and the detection of the battery voltage is performed in the period, following which the control of switching the output mode to select the one according to the battery voltage is carried out.

According to the charging power source apparatus 10B of the present embodiment, it is possible to return the secondary battery E2 to a voltage at which quick charging can be carried out by performing pre-charging when the battery voltage is very low. Moreover, at charging starting time, voltage detection is performed at the current value of pre-charging, and the output mode is switched to a pertinent one. Consequently, the effect can be obtained that a disadvantage can be avoided that a quick current abruptly flows to impose a burden on the secondary battery E2 and the charging circuit 20.

### Fourth Embodiment

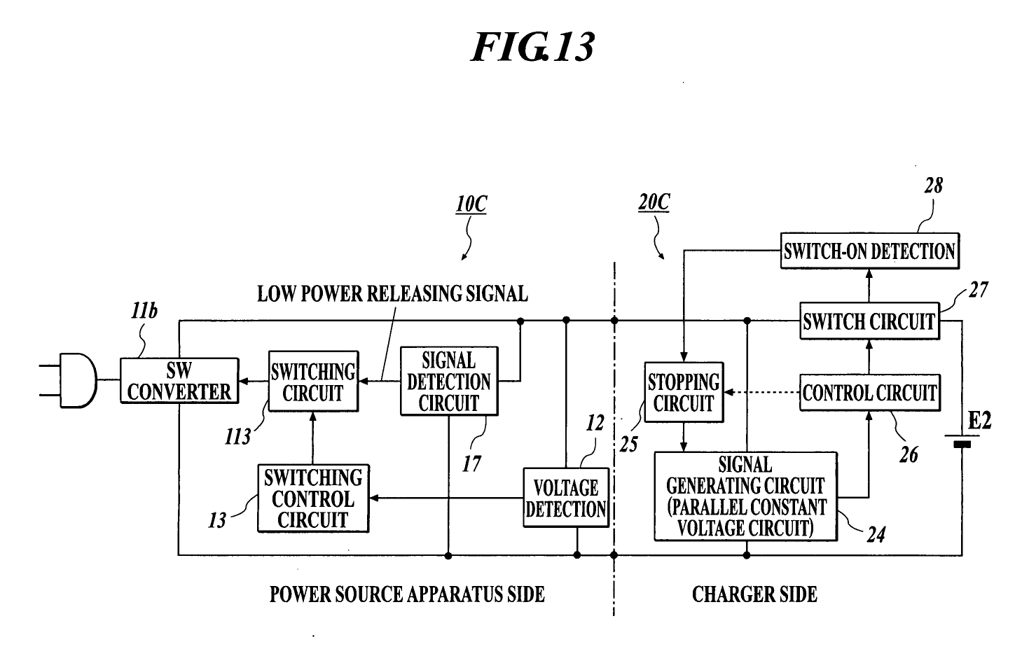

FIG. 13 shows a block diagram of a charging power source apparatus 10C of a fourth embodiment and a charging circuit 20C.

The charging power source apparatus 10C of the fourth embodiment is configured to be added with the output characteristic of the low power output mode to the configuration of the first embodiment similarly to the third embodiment, and further to perform output in the low power output mode as the initial state at the time of starting a charging operation. The configuration of the charging power source apparatus 10C is made to further perform the switching of the output mode according to the battery voltage and to start the charging operation after checking the connection of the charging circuit 20C.

Accordingly, the charging power source apparatus 10C is configured so that the selection state of the switching circuit 113 to determine the output characteristic of a SW converter 11b may be fixed to the low power output mode at the charging starting time and the selection state may be continued until a low power releasing signal is input.

Moreover, the charging power source apparatus 10C is configured to be provided with a signal detection circuit 17 to detect and check the connection of the charging circuit 20C. If the signal detection circuit 17 checks the connection of the charging circuit 20C, then the signal detection circuit 17 outputs a low power releasing signal to the switching circuit 113, and consequently the switching circuit 113 receives a control signal from the switching control circuit 13.

As the configuration of detecting and checking the connection of the charging circuit 20C with the signal detection circuit 17, for example, the following configuration can be applied.

First, as the configuration of the charging circuit 20C, a parallely connected type constant voltage circuit 24 is provided between the input terminals, and the charging circuit 20C is configured so as to perform the following operations: turning on a switch circuit 27 when the constant voltage circuit 24 operates to make a charging current flow into the secondary battery E2, and stopping the parallel constant voltage circuit 24 to shift the operation of the charging circuit 20C to its normal charging operation when the switch circuit 27 is turned on. The stopping of the parallel constant voltage circuit 24 can be carried on by detecting the turning-on operation of the switch circuit 27 to stop the parallel constant voltage circuit 24, or by supplying a signal at the time of operating the switch circuit 27 to be turned on from a control circuit 26 to stop the parallel constant voltage circuit 24 by the signal.

On the other hand, the signal detection circuit 17 of the power source apparatus 10C is configured to be able to detect the operation of the parallel constant voltage circuit 24 by collating a voltage change and a current change that indicate the operation of the parallel constant voltage circuit 24 of the charging circuit 20C with a predetermined pattern.

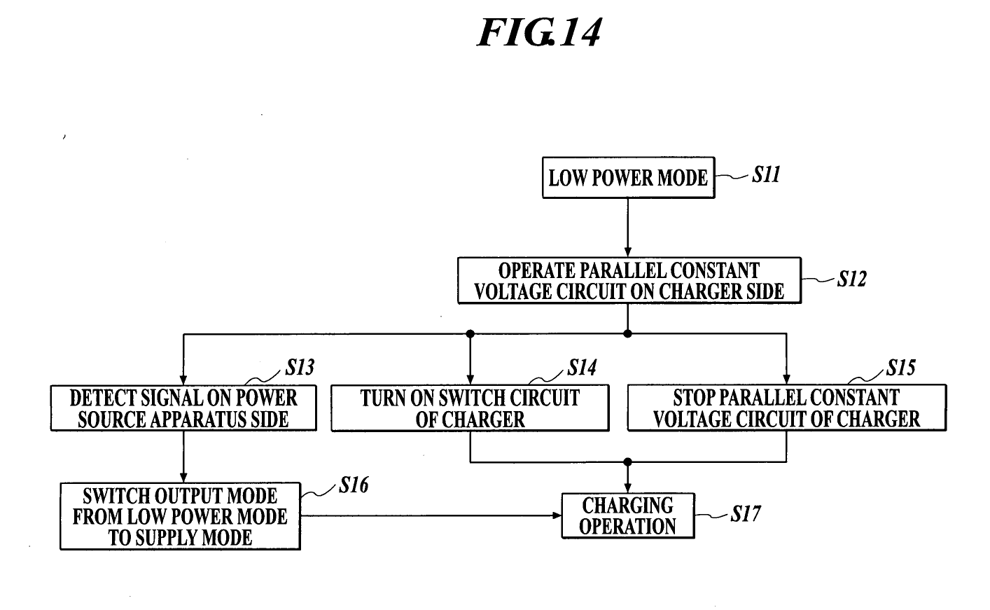

Next, the startup operation of the charging power source apparatus 10C will be described with reference to a flow chart of FIG. 14. FIG. 14 is the flow chart for illustrating the startup operation of the charging power source apparatus 10C.

When something is connected to the output terminals of the charging power source apparatus 10C, the charging power source apparatus 10C first starts current output in the low power output mode (Step S11). If the connected thing is the previously arranged charging circuit 20C, then the parallel constant voltage circuit 24 of the charging circuit 20C operates to transmit an operation signal to the side of the power source apparatus 10C.

Then, the signal detection circuit 17 in the power source apparatus 10C detects the signal (Step S13), and the switch circuit 27 of the charging circuit 20C is turned on at the same time (Step S14) to stop the parallel constant voltage circuit 24 (Step S15).

Furthermore, in the power source apparatus 10C, the low power output mode is released on the basis of the signal detection, and the current supply is performed in an output mode according to the output voltage (Step S16). In the charging circuit 20C, a charging operation is performed on the basis of the reception of the current supply (Step S17).

As described above, according to the charging power source apparatus 10C of the fourth embodiment, the current output in the low power output mode is performed at the connection starting time, and the current output is switched to the one in a pertinent output mode after checking the connection of the charging circuit 20C. Consequently, the charging power source apparatus 10C has the advantage of enabling the prevention of any large current flow if the output terminals are short-circuited or if another unrelated circuit is connected to the output terminals.

### Fifth Embodiment

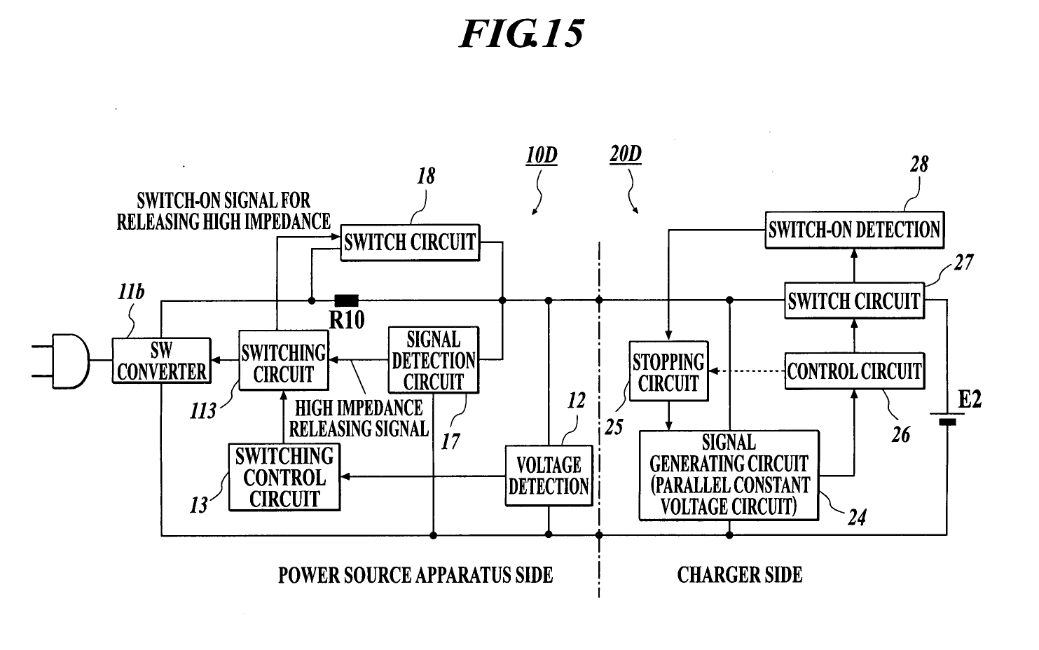

FIG. 15 shows a block diagram of a charging power source apparatus 10D of a fifth embodiment and a charging circuit 20D.

The charging power source apparatus 10D of the fifth embodiment is configured to start a charging operation after checking the connection of the charging circuit 20D similarly to the fourth embodiment, but the present embodiment is configured to make the output of the power source apparatus 10D be in a high impedance state at the time of performing connection checking, although the fourth embodiment is configured to set the output mode to the low power output mode at the time of performing the connection checking.

Accordingly, the charging power source apparatus 10D is provided with a high impedance element R10, such as a resistance element, which makes the output terminals to be in the high impedance state, and a switch circuit 18, which is connected in parallel with the high impedance element R10 for making the high impedance element R10 work on the output terminals and releasing the working.

Then, at the time of reset when the connection to the output terminals of the power source apparatus 10D is taken off, or when the plug of the power source apparatus 10D is drawn out from a plug receptacle and no electric source input exists, the charging power source apparatus 10D is configured to perform the following operations: the switch circuit 18 is turned off, and the output terminals are put in the high impedance state.

Moreover, the charging power source apparatus 10D is configured so as to output a switch-on signal to the switch circuit 18 through the switching circuit 113 to release the high impedance state of the output terminals when the signal detection circuit 17 detects a signal at the time of the connection of the charging circuit 20D.

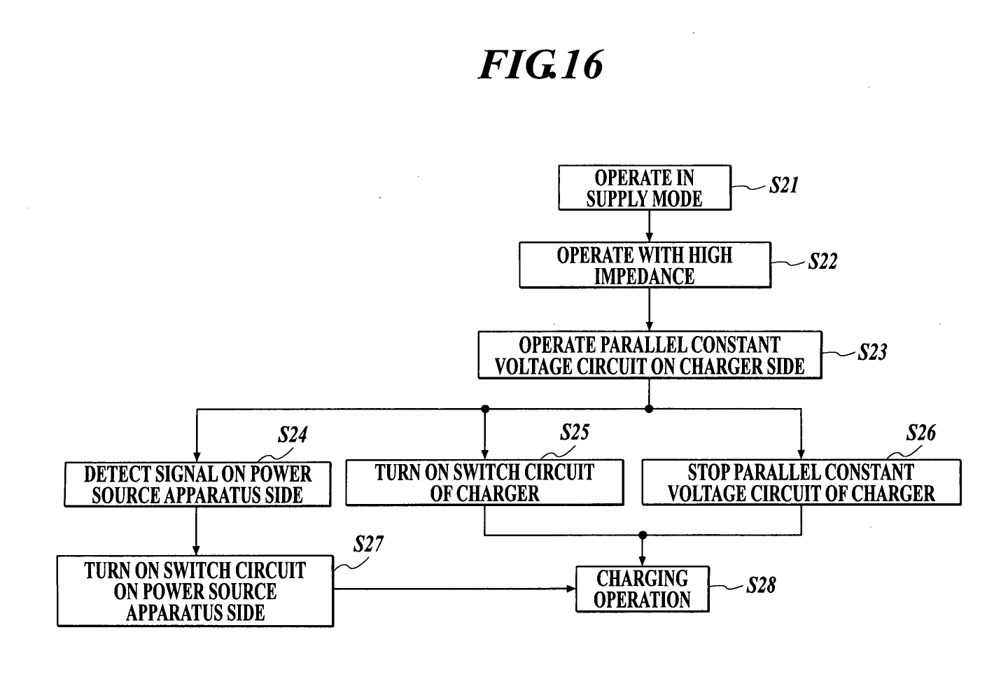

Next, the startup operation of the charging power source apparatus 10D will be described with reference to a flow chart of FIG. 16. FIG. 16 is the flow chart for illustrating the flow of the startup operation of the charging power source apparatus 10D.

In the initial state of the charging power source apparatus 10D after a reset thereof, the SW converter 11b performs an output operation in an output mode according to an output voltage (Step S21), and the switch circuit 18 is turned off. Then the output terminals are made to be put in their high impedance states (Step S22). When the previously arranged charging circuit 20D is connected here, the parallel constant voltage circuit 24 of the charging circuit 20D first operates, and the operation signal thereof is transmitted to the side of the power source apparatus 10D.

Then, in the power source apparatus 10D, the signal detection circuit 17 detects the signal (Step S24), and the switch circuit 27 of the charging circuit 20D is turned on at the same time (Step S25). Furthermore, the parallel constant voltage circuit 24 is stopped (Step S26).

Moreover, in the power source apparatus 10D, the switch circuit 18 is turned on by the signal detection, and the high impedance state is released. Then the current supply according to the output mode is performed (Step S27). Then, the charging circuit 20D receives the current supply to perform a charging operation (Step S28).

As described above, according to the charging power source apparatus 10D of the present embodiment, if something is connected to the output terminals, then the charging power source apparatus 10D checks the connection of the charging circuit 20D with the output terminals being put in the high impedance state, and releases the high impedance state to carry out the current output in a pertinent output mode after checking the connection of the charging circuit 20D. Consequently, the charging power source apparatus 10D has the advantage of enabling the prevention of any large current flow if the output terminals are short-circuited, or if the charging power source apparatus 10D is connected to another unrelated circuit.

Incidentally, although the present embodiment is configured to release the high impedance state when the connection of the charging circuit 20D is checked by the signal detection circuit 17, the charging power source apparatus 10D may be configured to perform the timing of a predetermined period with a timer or the like after the connection of something to the output terminals and the start of an output current flow, and to release the high impedance state automatically after the lapse of a predetermined period.

Even if the charging power source apparatus 10D is configured in such a way, the charging power source apparatus 10D has the advantage of enabling the prevention of a large current flow when temporal short-circuit of the output terminals and temporal improper connection are caused.

### Sixth Embodiment

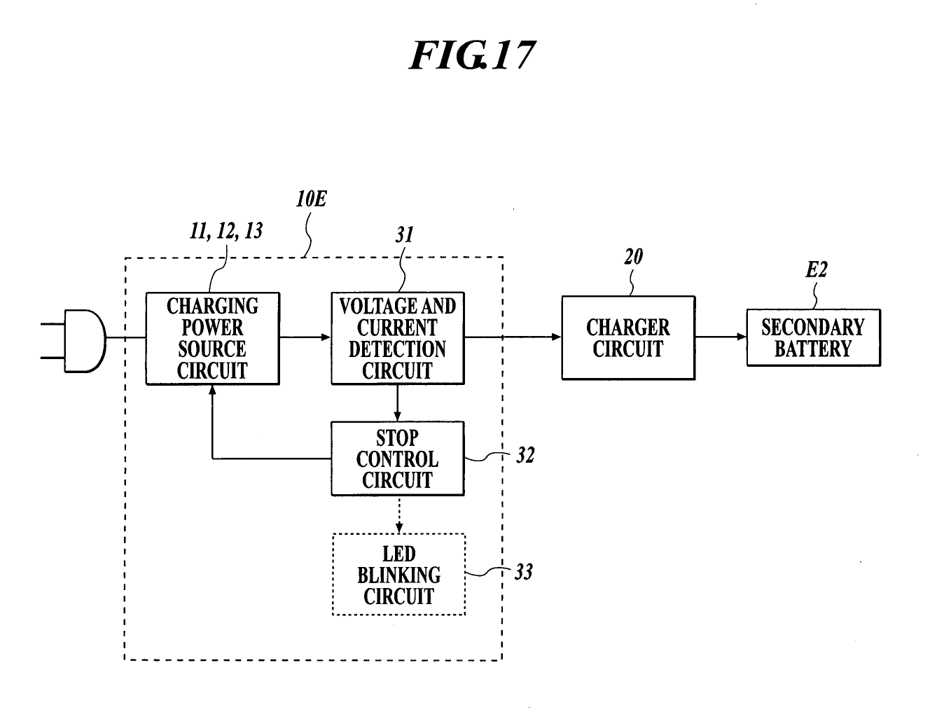

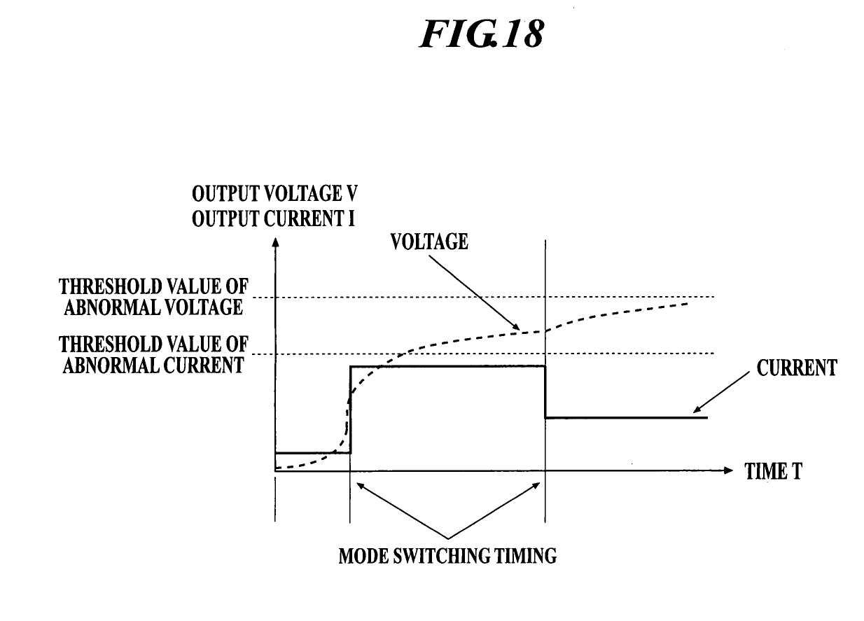

FIG. 17 is a block diagram showing the schematic configuration of a charging power source apparatus 10E of a sixth embodiment, and FIG. 18 is a graph showing an output characteristic during a charging operation of the charging power source apparatus 10E.

The charging power source apparatus 10E of the sixth embodiment is configured to be added with a protection function of stopping the output operation thereof when an output voltage or an output current reaches an abnormal value, in addition to the configuration of the first embodiment.

That is, the charging power source apparatus 10E is provided with a voltage and current detection circuit 31 to carry out the detection of an abnormal output current and an abnormal output voltage and a stop control circuit 32 to stop the operation of the charging power source circuits (including the SW converter circuit 11, the voltage detection circuit 12, and the switching control circuit 13) shown in FIG. 1 when a detected voltage or a detected current exceeds the abnormal value, in addition to the charging power source circuits.

Moreover, the charging power source apparatus 10E may be provided with a display, such as a light emitting diode (LED), and a circuit 33 to blink the display to perform the blinking display of the LED or the like on the basis of a signal from the stop control circuit 32 when the output operations of the charging power source circuits are stopped by the control of the stop control circuit 32.

The detection of the abnormal voltage and the abnormal current can be configured by setting threshold values of the abnormal voltage and abnormal current, which threshold values cannot be taken in normal charging operations, for the abnormality detection when the voltage and current values exceed the threshold values, as shown in FIG. 18.

Incidentally, although the threshold values of the abnormal voltage and abnormal current are made to be constant even if the output mode is changed, in the example of FIG. 18, the threshold values may be changed every output mode. In that case, the charging power source apparatus 10E may be configured to inform the stop control circuit 32 of the switched state of the output mode from the switching control circuit 13, and to change the setting of the threshold values according to the informed switched state.

According to the charging power source apparatus 10E of the present embodiment, when some abnormality arises and an output voltage or an output current shows an abnormal value, the output operation of the charging power source apparatus 10E is stopped by the protection function, and consequently high safety can be insured.

In the above, the best modes of implementing the present invention have been described, but the present invention is not limited to the first to sixth embodiments described above, and various modifications can be performed. For example, although the charging power source apparatus have been described as the ones for charging a lithium ion battery in the above-mentioned embodiments, the charging power source apparatus can be similarly applied to a nickel hydrogen battery and the other secondary batteries. Moreover, the current values and voltage values of each of the output characteristics shown in the embodiments are only parts of them, and the values should be suitably selected according to the kinds and capacities of the secondary batteries, the configurations of the charging circuits, and the like.

In addition, the circuit configurations and operation methods that have been concretely shown in the embodiments can be suitably changed without departing from the sprit and scope of the invention.

### INDUSTRIAL APPLICABILITY

The present invention can be used for a charging power source apparatus to supply electric power to a charger of a secondary battery.

1-13. (canceled)

14. A quick charging power source apparatus comprising:
a switch control circuit for performing switching of:
a pre-charging mode to perform charging with a charging current smaller than a normal charging current of a secondary battery at startup time when the charging is started;
a quick charging mode to perform charging with a charging current larger than the normal charging current after an output voltage returns to a reference voltage capable of quick charging in the pre-charging mode;
a normal charging mode to perform charging with the normal charging current when the output voltage reaches a predetermined switching reference voltage or more in the quick charging mode; and
a constant voltage charging mode to perform constant voltage charging when the output voltage reaches a full charge voltage or more in the normal charging mode.

15. The quick charging power source apparatus according to claim 14, further comprising:
a switch circuit for connecting/releasing a high impedance circuit to/from output terminals, wherein
an output operation is started in a state of connecting the high impedance circuit when a current output is started in a state in which the current output is zero.

16. The quick charging power source apparatus according to claim 14, further comprising:
a detection circuit for detecting the output voltage or an output current; and
a stopping circuit for stopping the output operation when the detection circuit detects an abnormal output voltage or an abnormal output current.

17. The quick charging power source apparatus according to claim 14, wherein
the charging current in the pre-charging mode is within a range from 0.02 C to 0.2 C of the secondary battery of a charging object.

18. The quick charging power source apparatus according to claim 14, wherein
the charging current in the quick charging mode is 2 C or more of the secondary battery of a charging object.

19. The quick charging power source apparatus according to claim 14, wherein
the charging current in the normal charging mode is within a range from 0.8 C to 1.2 C of the secondary battery of a charging object.
